(19) United States
(12) Patent Application Publication
(10) Pub. No.: US 2007/0136767 A1
(43) Pub. Date: Jun. 14, 2007

(54) Apparatus and method for controlling internet set-top box using Megaco protocol

(75) Inventors: Seung Han Choi, Gyeonggi-do (KR); Dong Myung Sul, Daejeon-city (KR); Kyung Hee Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/605,626

(22) Filed: Nov. 28, 2006

(30) Foreign Application Priority Data
Dec. 8, 2005 (KR) 10-2005-0119272

(51) Int. Cl. H04N 7/173; H04N 7/16; H04N 7/18

(52) U.S. Cl. 725/80; 725/110; 725/112; 725/100; 725/131; 725/139

(57) ABSTRACT

Provided is an apparatus and method for controlling an Internet set-top box. The apparatus includes: a receiving unit analyzing a control request included in an Internet protocol (IP) packet received from a server providing a multimedia service using the Megaco protocol; and a controller performing at least one of a function of setting a connection with the server, a function of generating a Megaco termination corresponding to the multimedia service provided by the server, and a function of setting a connection between at least two generated Megaco terminations, in response to the control request.

### CROSS-REFERENCE TO RELATED PATENT APPLICATION

This application claims the benefit of Korean Patent Application No. 10-2005-0119272, filed on Dec. 8, 2005, in the Korean Intellectual Property Office, the disclosure of which is incorporated herein in its entirety by reference.

### 1. FIELD OF THE INVENTION

The present invention relates to an apparatus and method for controlling an Internet set-top box, and more particularly, to an apparatus and method for controlling an Internet set-top box providing an Internet telephone service and an Internet broadcasting service to a subscriber using the Megaco protocol in an Internet network providing various Internet services such as the Internet telephone service and the Internet broadcasting service.

### 2. DESCRIPTION OF THE RELATED ART

Since conventional set-top boxes do not have a control method for providing an Internet broadcasting service, an Internet telephone service, and a set-top box maintenance function, extensibility and maintenance are limited due to the limitation of the control method.

Even if relevant control methods exist, since a set-top box have a different control method for each of the Internet broadcasting service, the Internet telephone service, and the set-top box maintenance function, costs required for the set-top box are increasing.

The Megaco protocol is a protocol for controlling a media gateway in which softswitches are physically separated, controls devices for processing a media stream, such as a broadcasting stream, image and voice information for an Internet telephone, and so on, and has extensibility for processing a media stream corresponding to another service.

The Megaco protocol is also called an H.248 protocol, is a standard protocol standardized by International Telecommunication Union—Telecommunication (ITU-T) and Internet Engineering Task Force (IETF), and a master-slave type control protocol used to control media control devices in an Internet network.

The Megaco protocol has an optimal structure for controlling devices processing a media stream, such as a broadcasting stream, image and voice information for an Internet telephone, and so on, and has extensibility for processing a media stream corresponding to another service.

### SUMMARY OF THE INVENTION

The present invention provides an apparatus and method for controlling an Internet set-top box in common using the Megaco protocol when services, such as an Internet broadcasting service and an Internet telephone service, are provided.

According to an aspect of the present invention, there is provided an apparatus for controlling an Internet set-top box, the apparatus comprising: a receiving unit analyzing a control request included in an Internet protocol (IP) packet received from a server providing a multimedia service using the Megaco protocol; and a controller performing at least one of a function of setting a connection with the server, a function of generating a Megaco termination corresponding to the multimedia service provided by the server, and a function of setting a connection between at least two generated Megaco terminations, in response to the control request.

The apparatus may further comprise a transmitting unit transmitting a result of the control request processed by the controller to the server.

The apparatus may further comprise a classifying & processing unit classifying the generated Megaco termination according to a type of the multimedia service provided by the server and processing the classified Megaco termination.

According to another aspect of the present invention, there is provided a method of controlling an Internet set-top box, the method comprising: (a) receiving an Internet protocol (IP) packet from a server providing a multimedia service using the Megaco protocol; (b) analyzing a control request included in the IP packet; and (c) performing at least one of a function of setting a connection with the server, a function of generating a Megaco termination corresponding to the multimedia service provided by the server, and a function of setting a connection between at least two generated Megaco terminations, in response to the control request.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic configuration of an Internet service system using a Megaco Internet set-top box according to an embodiment of the present invention;

FIG. 2 is a block diagram of an Internet set-top box according to an embodiment of the present invention;

FIG. 3 is a block diagram of an Internet set-top box control apparatus according to an embodiment of the present invention; and

FIG. 4 is a block diagram of an Internet set-top box control apparatus according to another embodiment of the present invention.

### DETAILED DESCRIPTION OF THE INVENTION

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

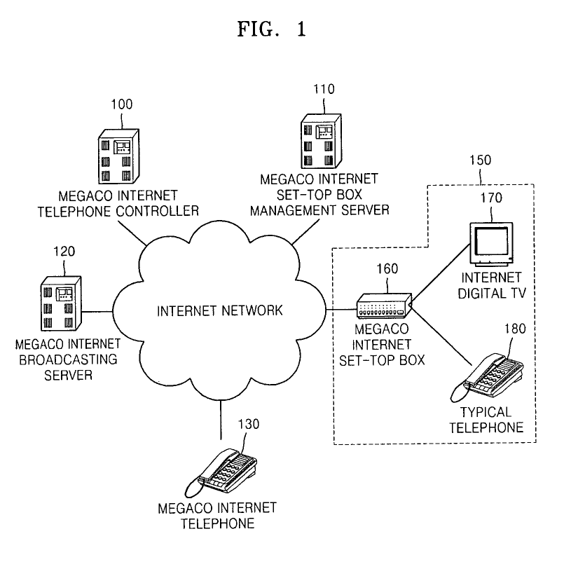

FIG. 1 is a schematic configuration of an Internet service system using a Megaco Internet set-top box according to an embodiment of the present invention.

FIG. 1 illustrates a Megaco Internet set-top box to which an apparatus and method for controlling an Internet set-top box using the Megaco protocol according to an embodiment of the present invention is applied and an environment for providing an Internet telephone service, an Internet broadcasting service, and an Internet set-top box maintenance service in an Internet network.

The Internet telephone service is provided by a Megaco Internet telephone controller 100 controlling a Megaco Internet telephone 130 and a Megaco Internet set-top box 160 to which a typical telephone 180 is connected.

The Internet broadcasting service is provided by a Megaco Internet broadcasting server 120 controlling the Megaco Internet set-top box 160 to which an Internet digital television (TV) 170 is connected and transmitting a broadcasting stream to the Megaco Internet set-top box 160.

The Internet set-top box maintenance service is provided by a Megaco Internet set-top box management server 110 controlling the Megaco Internet set-top box 160.

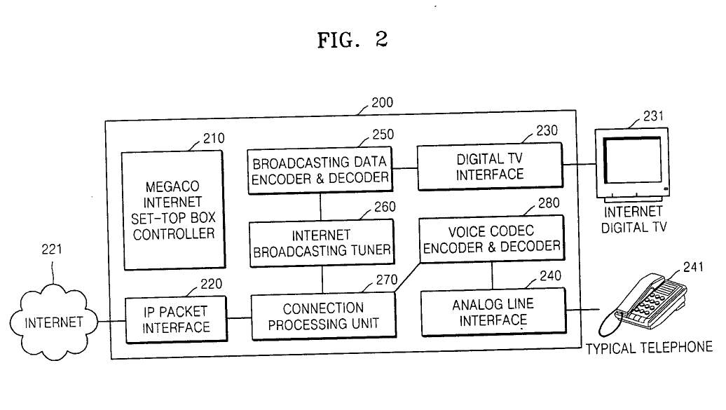

FIG. 2 is a block diagram of an Internet set-top box 200 according to an embodiment of the present invention.

Referring to FIG. 2, the Internet set-top box 200 includes a Megaco Internet set-top box controller 210, an IP packet interface 220, a digital TV interface 230, an analog line interface 240, a broadcasting data encoder & decoder 250, an Internet broadcasting tuner 260, a connection processing unit 270, and a voice codec encoder & decoder 280.

The IP packet interface 220 transmits and receives an IP packet including a Megaco packet, an Internet broadcasting stream, and voice data. The digital TV interface 230 transmits image and voice information, which a digital TV can present, to an Internet digital TV 231. The analog line interface 240 transmits and receives voice information to and from a typical telephone 241.

The broadcasting data encoder & decoder 250 converts the Internet broadcasting stream transmitted through the connection processing unit 270 and extracted by the Internet broadcasting tuner 260 into image and voice information, which a digital TV can present.

The Internet broadcasting tuner 260 extracts the Internet broadcasting stream from the IP packet, and the connection processing unit 270 transfers the IP packet including the Internet broadcasting stream and the voice data between the IP packet interface 220 and the Internet digital TV 231 and between the IP packet interface 220 and the analog line interface 240.

The voice codec encoder & decoder 280 extracts the voice data from the IP packet transmitted from the connection processing unit 270 and converts the extracted voice data into voice information, which a general analog telephone can present.

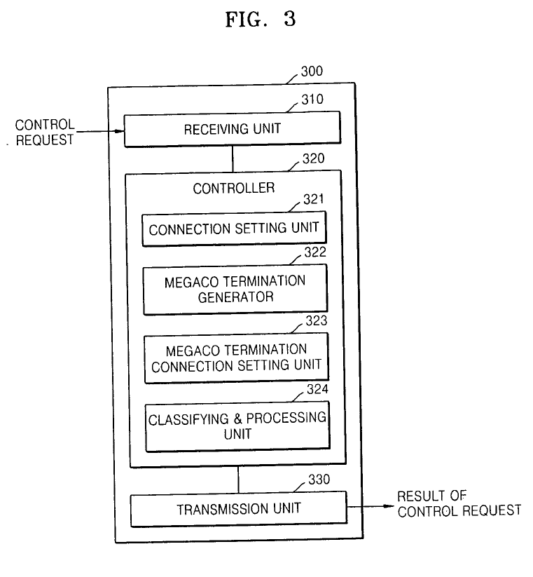

FIG. 3 is a block diagram of an Internet set-top box control apparatus 300 according to an embodiment of the present invention.

Referring to FIG. 3, the Internet set-top box control apparatus 300 includes a receiving unit 310, a controller 320, and a transmission unit 330.

The receiving unit 310 analyzes a Megaco control request included in an IP packet received from a server providing a multimedia service using the Megaco protocol.

The controller 320 performs, in response to the Megaco control request, which is included in the IP packet, analyzed by the receiving unit 310, a function of setting a connection with the server providing the multimedia service using the Megaco protocol, a function of generating a Megaco termination corresponding to the multimedia service provided by the server providing the multimedia service using the Megaco protocol, a function of setting a connection between at least two generated Megaco terminations, and a function of processing the generated Megaco terminations by classifying the generated Megaco terminations according to a type of the multimedia service, i.e., a voice data, broadcasting stream, or analog stream type, provided by the server.

In more detail, the controller 320 includes a connection setting unit 321, a Megaco termination generator 322, a Megaco termination connection setting unit 323, and a classifying & processing unit 324.

When the Megaco control request received by the receiving unit 310 is a request for connecting with a multimedia providing server, the connection setting unit 321 sets a connection with a server providing a multimedia service using the Megaco protocol, e.g., the Megaco Internet telephone controller 100, the Megaco Internet set-top box management server 110, or the Megaco Internet broadcasting server 120 illustrated in FIG. 1.

When the Megaco control request received by the receiving unit 310 is a request for setting a Megaco termination, the Megaco termination generator 322 generates, deletes, or modifies the Megaco termination in response to the Megaco control request.

The Megaco termination is a basic unit for controlling broadcasting stream, voice data, or maintenance management information and can be variously defined as, for example, an Internet interface Megaco termination, an analog interface Megaco termination, an Internet digital TV interface Megaco termination, or a set-top box management Megaco termination.

If the request for setting, e.g., generating, deleting, or modifying, a Megaco termination is received, the Megaco termination generator 322 generates a new Megaco termination, modifies attribute information or Megaco package information of the Megaco termination, or deletes the existing Megaco termination. The generated Megaco termination is stored in a Megaco termination database (not shown), and the Megaco termination generator 322 also provides a function of searching the Megaco termination database.

When the Megaco control request received by the receiving unit 310 is a request for setting a Megaco termination connection, the Megaco termination connection setting unit 323 performs a connection or release between more than two Megaco terminations.

In detail, to watch an Internet broadcasting program through an Internet digital TV connected to an Internet set-top box, the Internet interface Megaco termination for receiving a broadcasting stream through the Internet must be connected to the Internet digital TV interface Megaco termination for transmitting the broadcasting stream to the Internet digital TV.

Likewise, to use an Internet telephone service through a typical telephone, the Internet interface Megaco termination for receiving voice data through the Internet must be connected to the analog interface Megaco termination for transmitting the voice data to the typical telephone.

In addition, when the Internet broadcasting service or the Internet telephone service is finished, the existing connection between Megaco terminations must be released. The Megaco termination connection setting unit 323 performs such a connection or release between the Megaco terminations.

When the Megaco control request received by the receiving unit 310 is a request for processing a Megaco termination, the classifying & processing unit 324 classifies the Megaco termination according to a type of the multimedia service provided by the server and processes the classified Megaco termination.

For example, when a Megaco Internet set-top box management request is received by the receiving unit 310, the classifying & processing unit 324 classifies a control operation for a software upgrade of a Megaco Internet set-top box, a software error report of the Megaco Internet set-top box, a hardware error report of the Megaco Internet set-top box, software error statistics of the Megaco Internet set-top box, and a load information collection of the Megaco Internet set-top box, which are included in a management attribute of the Megaco Internet set-top box, as a Megaco Internet set-top box package and processes the classified Megaco Internet set-top box package differently from other Megaco terminations.

When an analog interface management request is received by the receiving unit 310, the classifying & processing unit 324 classifies generation and detection of a dual tone multi-frequency (DTMF), analog interface state management, telephone button map information, and an analog interface state report as an analog interface Megaco termination package and processes the classified analog interface Megaco termination package differently from other Megaco terminations.

When an Internet digital TV control request is received by the receiving unit 310, the classifying & processing unit 324 classifies an Internet digital TV input/output interface method, an Internet broadcasting stream transmission method, and an Internet digital TV state report, which are included in an attribute of the Internet digital TV interface Megaco termination, as an Internet digital TV interface Megaco termination package and processes the classified Internet digital TV interface Megaco termination package differently from other Megaco terminations.

When an Internet interface control request is received by the receiving unit 310, the classifying & processing unit 324 classifies Internet packet statistics, jitter management, and an Internet interface state report as an Internet interface Megaco termination package and processes the classified Internet interface Megaco termination package differently from other Megaco terminations.

The above-description is only an embodiment that the classifying & processing unit 324 classifies a Megaco termination according to an attribute or characteristic of the Megaco termination and processes the classified Megaco termination, and the present invention is not limited to this. That is, the classifying & processing unit 324 can classify a Megaco termination as another embodimental form according to an attribute or characteristic of the Megaco termination and processes the classified embodimental form.

The transmitting unit 330 generates a result obtained by the controller 320 processing the Megaco control request received by the receiving unit 310 as a Megaco packet and transmits the generated Megaco packet to the server providing the multimedia service.

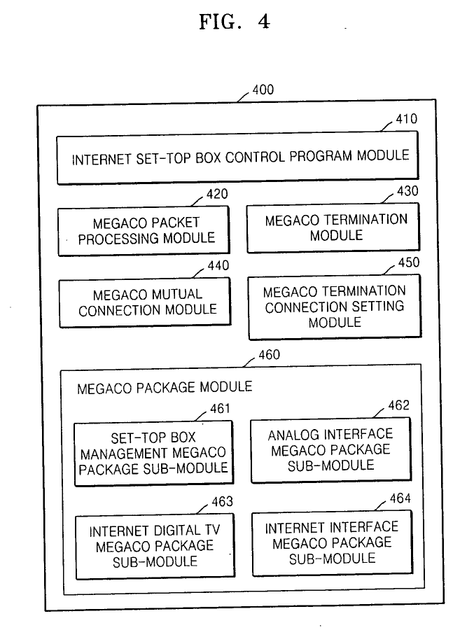

FIG. 4 is a block diagram of Internet set-top box control apparatus 400 according to another embodiment of the present invention.

Referring to FIG. 4, a Megaco packet processing module 420 analyzes a Megaco control request from an IP packet received from the outside and transmits a packet processed by a Megaco termination module 430, a Megaco mutual connection module 440, a Megaco termination connection setting module 450, or a Megaco package module 460 to the outside.

An Internet set-top box control program module 410 transmits the Megaco control request analyzed by the Megaco packet processing module 420 to the Megaco termination module 430, the Megaco mutual connection module 440, the Megaco termination connection setting module 450, and the Megaco package module 460 to perform at least one of a function of setting a connection with a server, a function of generating a Megaco termination corresponding to a multimedia service provided by the server, a function of setting a connection between at least two generated Megaco terminations, and a performing function according to a characteristic of each Megaco termination and receives a result obtained by performing the Megaco control request from each of the modules.

When the Megaco control request received from the Internet set-top box control program module 410 is a Megaco termination setting request, the Megaco termination module 430 performs generation, modification or deletion of a Megaco termination and transmits the performing result to the Internet set-top box control program module 410. The Megaco packet processing module 420 receives the result processed by the Megaco termination module 430, generates a Megaco control response packet, and transmits the generated Megaco control response packet to the external server, which has requested the control.

The Megaco mutual connection module 440 connects the Megaco Internet set-top box 160 to external servers, such as the Megaco Internet telephone controller 100, the Megaco Internet set-top box management server 110, and the Megaco Internet broadcasting server 120, and maintains the connection state.

The Megaco mutual connection module 440 also transmits a message for informing of the existence and service providing yes/no of the Megaco Internet set-top box 160 to external Internet set-top box control devices, such as the Megaco Internet telephone controller 100, the Megaco Internet set-top box management server 110, and the Megaco Internet broadcasting server 120. If a response according to the message is received from each of the external Internet control devices, the Megaco mutual connection module 440 sets a connection with each of the external Internet control devices and performs a control using the Megaco protocol. If a problem occurs in the connection with an existing Internet set-top box control device, the Megaco mutual connection module 440 tries to set a connection with a new Internet set-top box control device.

The Megaco termination connection setting module 450 sets a connection or release between at least two designated Megaco terminations and transmits the connection or release setting result to the Internet set-top box control program module 410. The Internet set-top box control program module 410 generates Megaco control response information based on the received connection or release setting result, and the Megaco packet processing module 420 converts the generated Megaco control response information to a Megaco control response packet.

The Megaco package module 460 receives a Megaco package processing request and determines which package sub-module should process the requested Megaco package. That is, the Megaco package module 460 classifies a Megaco termination according to a multimedia service type and characteristic and processes the classified Megaco termination.

To do this, the Megaco package module 460 includes a set-top box management Megaco package sub-module 461, an analog interface Megaco package sub-module 462, an Internet digital TV Megaco package sub-module 463, and an Internet interface Megaco package sub-module 464. Specific Megaco terminations processed by the Megaco package sub-modules 461 through 464 will now be described.

The set-top box management Megaco package sub-module 461 performs a control of a software upgrade of a Megaco Internet set-top box, a software error report of the Megaco Internet set-top box, a hardware error report of the Megaco Internet set-top box, software error statistics of the Megaco Internet set-top box, and a load information collection of the Megaco Internet set-top box whose Megaco termination attributes correspond to set-top box management.

The analog interface Megaco package sub-module 462 performs a control of generation and detection of a DTMF, analog interface state management, telephone button map information, and an analog interface state report whose Megaco termination attributes correspond to analog interface management.

The Internet digital TV Megaco package sub-module 463 performs a control of an Internet digital TV input/output interface method, an Internet broadcasting stream transmission method, and an Internet digital TV state report whose Megaco termination attributes correspond to Internet digital TV interface management.

The Internet interface Megaco package sub-module 464 performs a control of Internet packet statistics, jitter management, and an Internet interface state report whose Megaco termination attributes correspond to Internet interface management.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, by an apparatus and method for controlling an Internet set-top box using the Megaco protocol according to the embodiment of the present invention, the service maintaining costs can be reduced by providing a common control method for an Internet broadcasting service, an Internet telephone service, and a set-top box maintenance function to subscribers in an Internet network providing various Internet services such as the Internet broadcasting service and the Internet telephone service.

In addition, various services besides the Internet broadcasting service, the Internet telephone service, and the set-top box maintenance function can be easily added.

In addition, a structure of the Internet set-top box can be simplified, and resources of the Internet set-top box can be efficiently used.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for controlling an Internet set-top box, the apparatus comprising:
a receiving unit analyzing a control request included in an Internet protocol (IP) packet received from a server providing a multimedia service using the Megaco protocol; and
a controller performing at least one of a function of setting a connection with the server, a function of generating a Megaco termination corresponding to the multimedia service provided by the server, and a function of setting a connection between at least two generated Megaco terminations, in response to the control request.

2. The apparatus of claim 1, further comprising a transmitting unit transmitting a result of the control request processed by the controller to the server.

3. The apparatus of claim 1, wherein the controller further comprises a classifying & processing unit classifying the generated Megaco termination according to a type of the multimedia service provided by the server and processing the classified Megaco termination.

4. The apparatus of claim 1, wherein the function of generating a Megaco termination comprises a function of generating, deleting, and modifying the Megaco termination.

5. The apparatus of claim 1, wherein the function of setting a connection between at least two generated Megaco terminations comprises a function of setting a connection or release between the at least two generated Megaco terminations.

6. A method of controlling an Internet set-top box, the method comprising:
(a) receiving an Internet protocol (IP) packet from a server providing a multimedia service using the Megaco protocol;
(b) analyzing a control request included in the IP packet; and
(c) performing at least one of a function of setting a connection with the server, a function of generating a Megaco termination corresponding to the multimedia service provided by the server, and a function of setting a connection between at least two generated Megaco terminations, in response to the control request.

7. The method of claim 6, further comprising (d) transmitting a result of the control request processed in operation (c) to the server.

8. The method of claim 6, wherein operation (c) comprises:
(c1) classifying the generated Megaco termination according to a type of the multimedia service provided by the server and processing the classified Megaco termination.

9. The method of claim 6, wherein the function of generating a Megaco termination comprises a function of generating, deleting, and modifying the Megaco termination.

10. The method of claim 6, wherein the function of setting a connection between at least two generated Megaco terminations comprises a function of setting a connection or release between the at least two generated Megaco terminations.
